(19) United States
(12) Patent Application Publication
(10) Pub. No.: US 2026/0251280 A1
(43) Pub. Date: Aug. 27, 2026

(54) VEHICLE LAMP

(71) Applicant: Ichikoh Industries, Ltd., Isehara-shi (JP)

(72) Inventor: Sho IKENOUE, Isehara-shi (JP)

(73) Assignee: Ichikoh Industries, Ltd., Isehara-shi (JP)

(21) Appl. No.: 18/870,583

(22) PCT Filed: May 26, 2023
(86) PCT No.: PCT/JP2023/019795

§ 371 Date: Nov. 29, 2024

(30) Foreign Application Priority Data
May 31, 2022 (JP) 2022-089293

(51) Int. Cl. F21S 43/20; F21S 43/14; F21S 43/40; F21V 9/38

(52) U.S. Cl. CPC F21S 43/26231; F21S 43/14; F21S 43/26211; F21S 43/26261; F21S 43/281; F21S 43/402; F21V 9/38; F21S 2243/00

(57) ABSTRACT

A vehicle lamp having an excellent appearance by a holding member (inner housing and support part), an emission surface of an optical member faces a light emitting layer as a light emission surface of a light conversion member, and an excitation light source faces an incident surface of the optical member. Moreover, in a light emitting device of the vehicle lamp, the emission surface of the optical member is formed in a shape based on the shape of the light emitting layer as the light emission surface, and the excitation light source is disposed at a position based on the shape of the incident surface of the optical member.

### TECHNICAL FIELD

The present invention relates to a vehicle lamp that uses an inorganic or organic fluorescent material and photoluminescence to provide a good appearance.

### BACKGROUND ART

There is known a vehicle lamp for a vehicle including an excitation light source, a light emitting layer that emits light generated by emitting the excitation light from the excitation light source, and a lens member that emits the generated light from the light emitting layer (for example, see Patent Literature 1).

### CITATION LIST

### Patent Literature

Patent Literature 1: International Publication 2019/245030

### SUMMARY OF THE INVENTION

### Problems to be Solved by the Invention

A vehicle lamp that functions as a vehicle lamp using the above-described principle of vehicle lamps and that provides a more realistic and good appearance has not yet been developed.

An object of the present invention, which has been made in view of the above, is to provide a vehicle lamp having an excellent appearance.

### Means for Solving the Problem

A vehicle lamp according to an aspect of the present invention includes: a lamp housing and a lamp lens defining a space; an excitation light source that is disposed in the space and emits blue excitation light; an optical member that is disposed in the space to correspond to the excitation light source, receives excitation light emitted from the excitation light source, and emits parallel light or light close to parallel light; and a light conversion member disposed in the space, provided at a position to receive light from the optical member, and formed into a predetermined shape based on a light emission pattern P, wherein the lamp lens is a red lens or a separate red outer lens is provided outside the lamp lens.

### Effect of the Invention

The vehicle lamp of the present invention can provide a vehicle lamp having an excellent appearance.

### BRIEF DESCRIPTION OF THE DRAWINGS

FIGS. 1A to 1C are diagrams illustrating, in its entirety, a vehicle lamp 100 according to the present invention.

FIG. 2 is a longitudinal sectional view of the vehicle lamp 100.

FIG. 3 is a diagram for explaining the attachment of a light conversion member 34.

FIGS. 4A and 4B are diagrams for explaining a light conversion unit 3.

FIG. 5 is a cross-sectional view of an optical member 33.

FIG. 6 is a perspective view of a light conversion member.

FIGS. 7A and 7B are diagrams for describing the arrangement of optical members and excitation light sources.

FIG. 8 is a diagram for describing a positional relationship between optical members and light conversion members.

FIGS. 9A to 9C are cross-sectional views for describing another embodiment of the optical member 33.

### MODE FOR CARRYING OUT THE INVENTION

Embodiments (examples) of a vehicle lamp according to the invention will now be described in detail with reference to the drawings. The present invention is not limited to the embodiments. Components in the following embodiments include those that can be easily replaced by those skilled in the art, or those that are substantially the same. In the following description, each of the front-rear, up-down, and right-left directions is a direction of the vehicle lamp in an in-vehicle state and indicates a direction when the traveling direction of the vehicle is viewed from the driver's seat. In the present embodiment, the up-down direction is parallel to the vertical direction, and the left-right direction is the horizontal direction. Regarding a front direction and a rear direction, a direction in which light is emitted from the vehicle lamp is defined as the front direction, and a direction opposite to the front direction is defined as the rear direction.

### Description of Vehicle Lamp 100

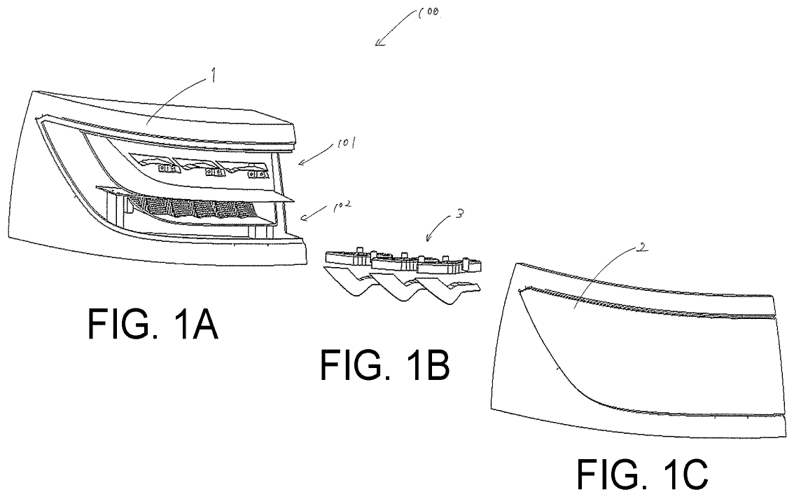

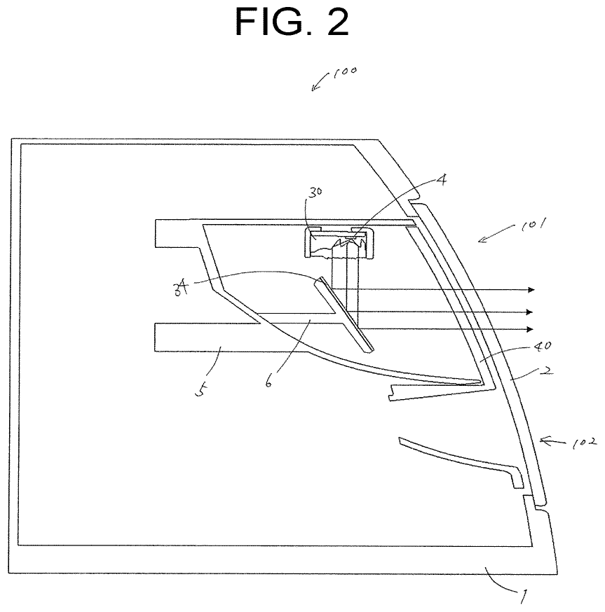

In this example, a vehicle lamp 100 is a rear combination lamp attached to each of the left and right sides of a rear portion of a vehicle (not illustrated). Therefore, in the first embodiment, the front direction is the rearward direction (vehicle rearward direction), and the rear direction is the forward direction (vehicle forward direction). FIG. 1A to FIG. 1C are diagrams illustrating the entirety of the rear combination lamp. FIG. 1A is a diagram illustrating the inside of a housing 1 provided in the vehicle. A tail lamp part 101 and a turn lamp part 102 are housed in the housing 1. FIG. 1B is a diagram illustrating a light conversion unit 3 incorporated in the tail lamp part 101. FIG. 1C is a diagram illustrating a state in which an outer lens 2 is fitted into the housing 1. FIG. 2 is a cross-sectional view of the vehicle lamp 100. The tail lamp part 101 and the turn lamp part 102 partitioned by an inner housing 5 are provided in the housing 1. An embodiment of the present invention will be described by using the configuration of the tail lamp part 101 as an example. The tail lamp part 101 includes a light source part 30 provided on the lower surface side of the ceiling surface of the inner housing 5, a light conversion member 34 that receives light from the light source part 30, converts the light, and emits the light in the front direction, an inner lens 40 that receives the light from the light conversion member 34 and emits the light to the outside of a vehicle through the outer lens 2, and a support part 6 that supports the light conversion member 34. The light source part 30 radiates blue light emitted from the excitation light source 4 as parallel light or nearly parallel light onto the light conversion member 34. The light conversion member 34 converts the blue light from the excitation light source 4 into red light and emits the resulting red light toward the inner lens 40 and the outer lens 2. The inner lens 40 and the outer lens 2 are disposed in the front direction with respect to the light conversion member 34. At least one of the inner lens 40 and the outer lens 2 is a red lens. As long as one of the lenses is red, the other lens may be a clear lens.

Since at least one of the inner lens 40 and the outer lens 2 is a red lens, the excitation light component included in the external light entering the vehicle lamp 100 from the outside of the vehicle is absorbed by the inner lens 40 or the outer lens 2. Therefore, it is possible to prevent the light conversion member 34 from emitting light due to the excitation light component included in the external light.

The inner housing 5 is formed of, for example, a resin material, such as a black resin material. A predetermined space is defined by the inner housing 5 and the inner lens 40.

### Description of Support Part 6 and Light Conversion Member 34

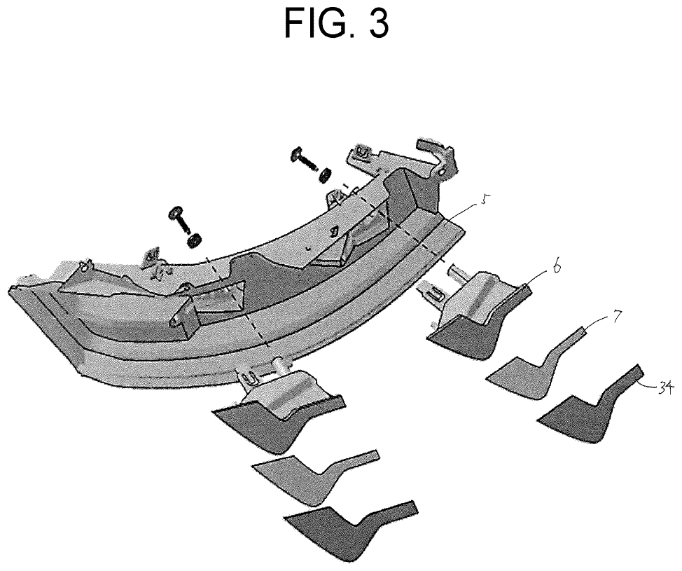

FIG. 3 is a diagram illustrating how the light conversion member 34 in FIG. 2 is mounted in the inner housing 5. In FIG. 3, the support part 6 attached to the inner housing 5 supports the light conversion member 34 via an adhesive sheet 7. The adhesive sheet 7 is an acrylic double-sided tape. The outer shapes of the support part 6 and the adhesive sheet 7 are formed in a shape (similar shapes) along the outer shape of the light conversion member 34. The outer shapes of the support part 6 and the adhesive sheet 7 may be the same shape as the outer shape of the light conversion member 34, a shape smaller than the light conversion member 34, or a shape larger than the light conversion member 34. The outer shape of the support part 6 may be a shape along at least a portion of the outer shape of the light conversion member 34.

### Description of Light Source Part 30

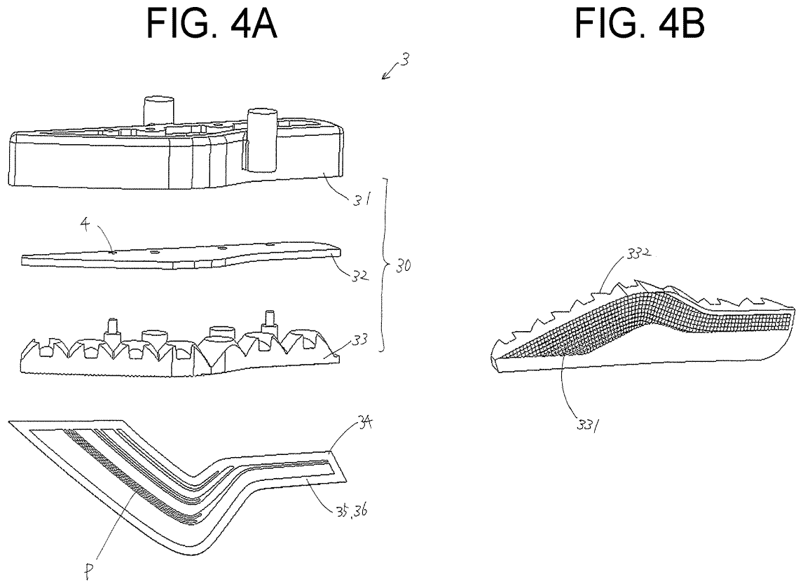

FIGS. 4A and 4B are diagrams for explaining the light conversion unit 3. In FIG. 4A, the light conversion unit 3 includes the light source part 30 and the light conversion member 34 including a substrate 35 and a light emitting layer 36. The light source part 30 includes the excitation light source 4, a support substrate 32 that supports the excitation light source 4, and an optical member 33 that converts blue excitation light from the excitation light source 4 into parallel light or nearly parallel light. FIG. 4B is an oblique bottom view of the optical member 33, in which a prism 331 is provided on the lower surface of the optical member 33 and the upper portion of a collimator lens 332 is visible.

The support substrate 32 supports the excitation light source 4. The support substrate 32 is supported by a cover 31, and the cover 31 is supported by the housing 1. The excitation light source 4 is, for example, a light source such as an LED or an organic EL. The excitation light source 4 is disposed, for example, above the light conversion member 34, and emits excitation light toward the optical member 33. The excitation light source 4 emits blue light as excitation light. The excitation light source 4 is not limited to a light source that emits blue light, and it is possible to use a light source capable of emitting light (violet light, ultraviolet light, or the like) having a shorter wavelength than the wavelength of the light generated in the light conversion member 34.

### Description of Optical Member 33

The optical member 33 is a lens that controls the excitation light emitted from the excitation light source 4 and causes the excitation light to enter the light conversion member 34. The optical member 33 faces the excitation light source 4. The optical member 33 includes an incident portion on which the excitation light from the excitation light source 4 is incident, a reflection portion that reflects the incident excitation light, and an emission portion that emits the excitation light to the light conversion member 34. The incident portion is provided to correspond to the number of excitation light sources 4.

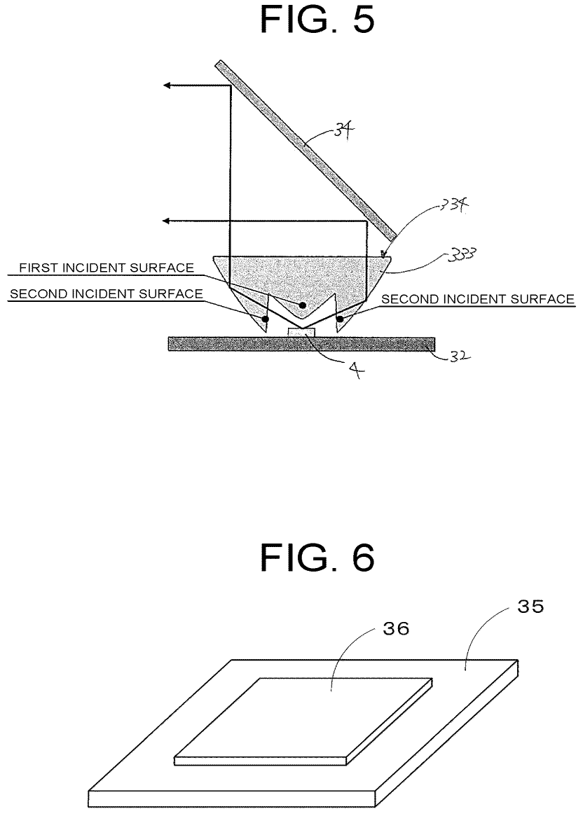

The optical member 33 reflects the excitation light incident from the incident portion by the reflection portion. The reflection portion controls the excitation light as parallel light to the emission portion side. The optical member 33 includes a collimator lens 333. FIG. 5 is a cross-sectional view of the optical member 33. In FIG. 5, for the sake of explanation, the positional relationship between the excitation light source 4 and the optical member 33 in FIG. 2 is shown upside down. A light incident portion of the collimator lens 333 has an M-shaped cross section, and has a so-called cup-shaped incident surface. When divergent excitation light from the excitation light source 4 is incident on the cup-shaped incident surface, the light becomes substantially parallel light on the emission surface 334 of the collimator lens 333 and is incident on the light conversion member 34. That is, in the drawing, the light incident from a first incident surface travels substantially straight and travels in the direction of the light conversion member 34, but the light incident from a second incident surface is once reflected by the lens side surface and travels in the direction of the light conversion member 34. In this way, the substantially parallel light can be incident on the light conversion member 34.

Furthermore, although not illustrated in the drawings, a diffusion prism may be formed on the emission surface 334 of the collimator lens 333. The diffusion prism may have a prism shape such as a fish-eye prism. This prism can locally and uniformly diffuse the light after the light is once converted into the parallel light and can suitably emit a pattern P of the light conversion member 34.

### Description of Light Conversion Member 34

The light conversion member 34 is disposed so as to obliquely tilt with respect to the front direction. As illustrated in FIG. 2, the light conversion member 34 is provided with a predetermined tilt with respect to the incident angle at which the excitation light is incident on the light conversion member 34. The angle is, for example, any angle within the range of 0 to 90 degrees, exclusive, and preferably 5 to 85 degrees. As the angle increases, the area of the light conversion member 34 viewed from above increases, and thus the light conversion member 34 can be easily irradiated with excitation light from above. In this way, light (red light, which is the secondary light) can be efficiently generated.

As illustrated in FIG. 3, the light conversion member 34 is bonded to the support part 6 attached to a portion of the inner housing 5 and is held at a desired angle. The light conversion member 34 is bonded to the support part 6 with an acrylic adhesive sheet. The light conversion member 34 may be bonded to the support part 6 with an adhesive agent.

In FIG. 2, the excitation light emitted from the excitation light source 4 is controlled by an inner lens severing as the optical member 33 and enters the light conversion member 34. A reflector may be used to control the excitation light emitted from the excitation light source 4 to be incident on the light conversion member 34.

### Description of Light Conversion Member 34, Holding Member 35, and Light Emitting Layer 36

A predetermined pattern P, as illustrated in FIG. 4A, is formed on the light conversion member 34. As illustrated in FIG. 6, the light conversion member 34 includes the substrate 35 and the light emitting layer 36.

The substrate 35 is made of an aluminum substrate, and the light emitting layer 36 is formed on the aluminum substrate. The substrate 35 has the same shape as the light emitting layer 36 and can be formed in the predetermined pattern P. Although the light emitting layer 36 is shown in a square shape in FIG. 6 in order to simplify the description, the light emitting layer 36 having a desired pattern P can be formed by applying an appropriate design mask in the process of forming the light emitting layer 36. The substrate 35 may be made of glass or the like.

Whether glass or aluminum is to be used for the substrate 35 is determined depending on the temperature at which the light emitting layer 36 is formed or design. When aluminum is used for the substrate 35, it functions as a reflecting means for reflecting light from the light emitting layer 36.

Furthermore, other transparent substrates also function as the substrate 35. When glass or a transparent substrate is used as the substrate 35, an aluminum plate may be attached to the back surface of the substrate 35 so that the aluminum plate functions as a reflecting means for reflecting light from the light emitting layer 36.

The light emitting layer 36 is held on one surface of the substrate 35. The light emitting layer 36 is excited by being irradiated with excitation light from the excitation light source 4, and emits generated light (red light, which is secondary light). The light emitting layer 36 is formed in a shape corresponding to, for example, the shape of the tail lamp in a front view. For example, as illustrated in FIG. 4A, the light emitting layer 36 has a predetermined pattern P.

In this embodiment, an inorganic material such as CASN (CaAlSiN₃:Eu) may be used as the light emitting layer 36. In this case, an inorganic light emitting layer can be formed by applying a mixed material of a transparent resin such as silicone and CASN onto the substrate 35 and baking it. An inorganic light emitting layer can also be formed by applying a mixed material of an inorganic material such as low melting point glass and CASN on the substrate 35 and baking it.

The inorganic light emitting layer may be, for example, a layer obtained by sintering a mixture of transparent resins (e.g., silicone) and CASN:Eu (powdery red luminous material) at 150 degrees Celsius. However, the inorganic light emitting layer is not limited to these specific examples, and any material that functions as an inorganic luminous body is within the scope of the present invention. For example, phosphor may be mixed in silicone, or phosphor may be mixed in epoxy.

When an inorganic material is used for the inorganic light emitting layer, a substrate made of, for example, aluminum can be used as the substrate 35. Other types of materials such as SCASN (Sr, Ca) AlSiN₃:Eu may be used for the inorganic light emitting layer.

### Explanation of Method for Producing Light Conversion Member 34 with Inorganic Material

A method of producing the light conversion member 34 including an inorganic luminous body will be explained. First, an inorganic solvent is prepared. A powdery glass frit having a desired softening point and a low melting point and a powdery fluorescent material (CaAISiN) called CASN are mixed with an organic solvent to prepare a desired solvent.

First, in step 1, a design mask layer for forming a desired pattern P is placed and fixed on a glass or aluminum substrate. In step 2, the prepared desired solvent is applied on the substrate on which the design mask layer has been formed. In step 3, the solvent that has overflowed above the design mask layer is removed. In step 4, only the design mask layer is removed, leaving only the portion of the solvent that is highly adherent to the substrate to retain its shape. In step 5, sintering is performed at a temperature equal to or higher than a predetermined temperature, and an unnecessary solvent is vaporized.

In this way, an inorganic luminous material layer 36 is formed in a desired pattern P on the substrate 35, and the substrate 35 and the inorganic luminous material layer 36 constitute the light conversion member 34.

Alternatively, the light conversion member 34 may be produced by a doctor blade method. In the doctor blade method, first, a wheel having multiple protrusions turns in a pool storing an inorganic luminous material having viscosity, so that the inorganic luminous material is caught by the protrusions. Next, the inorganic luminous material caught at a height equal to or higher than the height of the projections is scraped off by a doctor blade. Subsequently, a take-up roll facing the wheel turns in synchronization with the wheel, whereby the inorganic luminous material stored in the gaps between the protrusions is transferred onto the surface of the substrate moving with the turning of the take-up roll. Then, the inorganic luminous material transferred onto the substrate in the form of a layer is subjected to a drying process, and then transferred to a sintering process together with the substrate.

In this way, the inorganic luminous material 36 transferred to the substrate 35 forms the desired pattern P, and the substrate 35 and the inorganic luminous material 36 constitute the light conversion member 34.

The material of the substrate may be any material as long as it has durability against the heating temperature required for the above-described production process, and an aluminum substrate is preferable in consideration of flexibility and efficiency in the production, and a glass substrate is preferable in consideration of design.

As described above, the prepared light conversion member 34 is planar or substantially planar. Alternatively, the light conversion member 34 may have a curved surface, or may have a flat surface and a curved surface.

The desired pattern P illustrated in FIG. 4A is formed from the light emitting layer 36, and the portion other than the pattern P is a portion of the substrate where the inorganic luminous material layer is not formed by the design mask layer, that is, a portion of the substrate where the inorganic luminous material is not transferred.

The light emitting layer 36 may be made of an organic material to form an organic luminous body. The organic luminous body includes a substrate, an organic light emitting layer, an aluminum layer, and an encapsulation portion.

### Explanation of Method for Preparing Light Conversion Member 34 with Organic Material

In the case of an organic material, in step 1, a design mask layer made of stainless steel is formed on a glass substrate. In step 2, an organic light emitting layer made of an organic luminous material (fluorescent material) is deposited. The organic luminous material includes a main component that absorbs a blue energy component and an additive component that emits light from the light absorbed by the main component. The component ratio of the additive component is less than 10%. In step 3, an aluminum layer serving as a reflective material is deposited. In step 4, after the design mask layer is removed, a SiN layer is deposited by a CVD method to form an encapsulation portion made of the SiN layer. In step 5, an adhesive layer is formed, and in step 6, an aluminum material serving as a protective material is attached.

The thickness of the glass substrate is approximately 0.7 mm. The thickness of the organic light emitting layer is approximately 2000 angstroms. The thickness of the aluminum layer is approximately 100 to 1000 angstroms. The thickness of the SiN layer of the encapsulation portion is a few microns. The thickness of the adhesive layer is ten and several microns. The thickness of the aluminum material (protective material) is approximately 0.15 mm. In this way, the light conversion member 34 having the same desired pattern P as that of the inorganic luminous body can be produced.

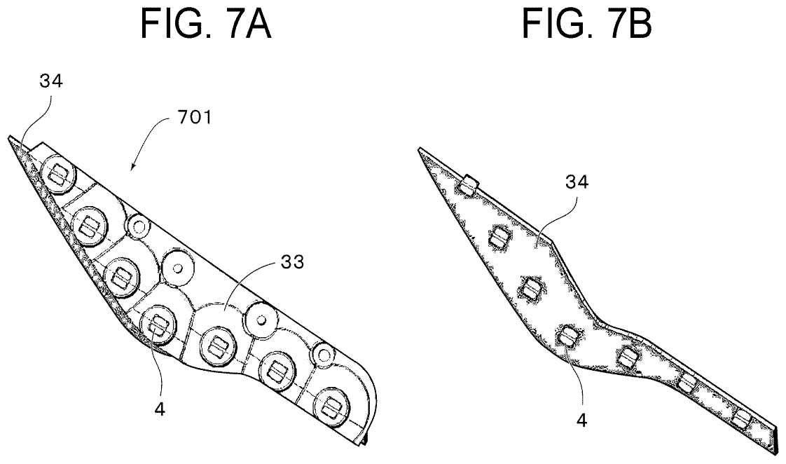

FIGS. 7A and 7B are diagrams for describing the arrangement of the optical members and the excitation light sources 4. FIG. 7A is a diagram illustrating an optical member unit 701 including seven optical members 33. The optical member unit 701 is integrally molded from an acrylic resin by injection molding. FIG. 7B is a diagram illustrating the arrangement of the seven excitation light sources 4. As can be seen from FIGS. 7A and 7B, the light source member unit is formed on the basis of the arrangement of the seven excitation light sources 4. Furthermore, in the optical member unit 701, screw holes for attaching the optical member unit 701 to the holding substrate are also integrally formed by injection molding.

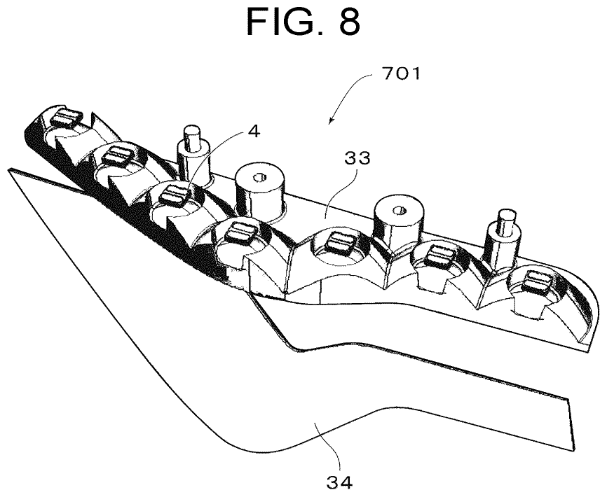

FIG. 8 is a diagram for describing the positional relationship between the optical members 33 and the light conversion member 34. The optical members 33 are formed so as to correspond to the shape of the light conversion member 34. Since the shape of the light conversion member 34 is determined on the basis of the light emission pattern P formed by the light emitting layer 36, it can be said that the optical members 33 are formed so as to correspond to the shape of the light emission pattern P. Similarly, the arrangement of the excitation light sources 4 is also determined on the basis of the shape of the light conversion member 34 or the shape of the light emission pattern P.

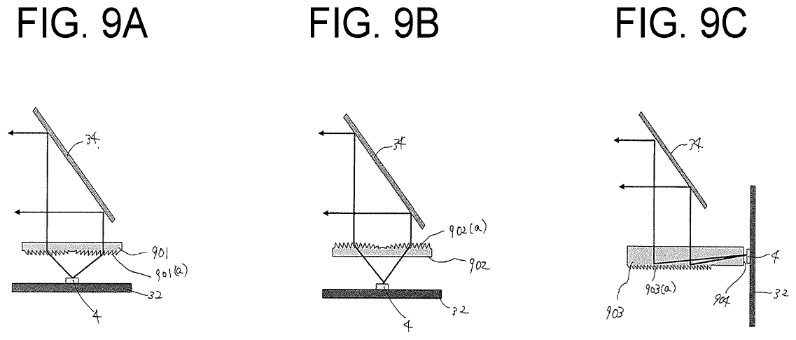

FIGS. 9A to 9C are cross-sectional views for explaining another embodiment of the optical member 33. FIG. 9A illustrates an embodiment in which a Fresnel lens 901 is used as the optical member 33. In this embodiment, the Fresnel lens 901 is disposed so that a Fresnel prism surface 901(a) of the Fresnel lens 901 faces the excitation light source 4. FIG. 9B illustrates an embodiment in which a Fresnel lens 902 is used as the optical member 33, but in this embodiment, the Fresnel lens 902 is disposed so that a Fresnel prism surface 902(a) of the Fresnel lens 902 is on the opposite side of the excitation light source 4. FIG. 9C illustrates an embodiment in which a rectangular light guide 903 is used as the optical member 33. A prism is formed on a side surface 903(a) of the light guide 903, and the light guide 903 is arranged and configured such that the excitation light 4 enters from one end 904.

In the present embodiment, the invention has been described by taking the tail lamp as an example, but the present invention can also be applied to a stop lamp, a turn lamp, a back lamp, and the like.

1. A vehicle lamp comprising:
a lamp housing and a lamp lens defining a space;
an excitation light source that is disposed in the space and emits excitation light,
an optical member that is disposed in the space to correspond to the excitation light source, receives the excitation light emitted from the excitation light source, and emits parallel light or light close to parallel light; and
a light conversion member disposed in the space, provided at a position to receive light from the optical member, and formed into a predetermined shape based on a light emission pattern P,
wherein the lamp lens is a red lens or a separate red outer lens is provided outside the lamp lens.

2. The vehicle lamp according to claim 1, wherein
a plurality of excitation light sources and a plurality of optical members are provided, and the excitation light sources and the optical members are provided at positions corresponding to a shape of the light conversion member or a shape of the light emission pattern P.

3. The vehicle lamp according to claim 2, wherein the excitation light sources are supported on a single support substrate, and the optical members include an optical member unit integrally formed from an acryl resin by injection molding.

4. The vehicle lamp according to claim 3, wherein, in the optical member unit, a screw hole for attaching the optical member unit to the support substrate is integrally formed by injection molding.

5. The vehicle lamp according to claim 1, wherein the optical member includes a collimator lens.

6. The vehicle lamp according to claim 4, wherein the optical member is provided with a prism at an emission portion of the optical member.

7. The vehicle lamp according to claim 1, wherein the optical member includes a Fresnel lens.

8. The vehicle lamp according to claim 1, wherein the optical member is provided with a prism at an incident portion of the optical member.

9. The vehicle lamp according to claim 1, wherein the excitation light source emits blue excitation light.

10. The vehicle lamp according to claim 1, wherein the light conversion member includes an inorganic material.

11. The vehicle lamp according to claim 1, wherein the light conversion member includes an organic material.

12. The vehicle lamp according to claim 1, wherein
the optical member includes an emission surface that emits, as emission light, the parallel light or the light close to parallel light, and
the light conversion member includes a light emitting layer that emits light by the excitation light, the light emitting layer being formed into a predetermined shape based on the light emission pattern P.

13. The vehicle lamp according to claim 12, wherein a shape of the emission surface of the optical member, when viewed from a direction opposite to a light emission direction of the emission light, is a shape which is formed based on a shape of the light emitting layer of the light conversion member, when viewed from the light emission direction of the emission light.
